(19) United States
(12) Patent Application Publication
(10) Pub. No.: US 2014/0025411 A1
(43) Pub. Date: Jan. 23, 2014

(54) AUTOMATIC CONFIGURATION OF PROCESS DEFINITION METRICS

(71) Applicants: Yi-Min CHEE, Yorktown Heights, NY (US); Daniel V. OPPENHEIM, Croton On Hudson, NY (US); Krishna C. RATAKONDA, Yorktown Heights, NY (US)

(72) Inventors: Yi-Min CHEE, Yorktown Heights, NY (US); Daniel V. OPPENHEIM, Croton On Hudson, NY (US); Krishna C. RATAKONDA, Yorktown Heights, NY (US)

(73) Assignee: INTERNATIONAL BUSINESS MACHINES CORPORATION, Armonk, NY (US)

(21) Appl. No.: 13/553,433

(22) Filed: Jul. 19, 2012

(51) Int. Cl. G06Q 10/00

(52) U.S. Cl. 705/7.11

(57) ABSTRACT

Various embodiments manage metrics in a business process management environment. In one embodiment, a business process is instantiated for execution. A set of process elements associated with the business process are identified. A set of metric configurations are accessed based on the business process being instantiated. A set of metrics is identified based on the set of metric configurations. Each of the set of metrics is associated with a process element type. At least one process elements in the set of process elements is automatically configured to collect at least one metric in the set of metrics based on the process element type of the at least one process element matching the process element type associated with the at least one metric.

### BACKGROUND

The present invention generally relates to business process management, and more particularly relates to a metrics framework for distributed service delivery.

In the context of globally distributed service delivery, service organizations that are spread across several geographic locations need to coordinate their work in order to deliver services. Examples include (but are not limited to) the design and development of software, application and system maintenance, and product development. These service organizations generally rely on human-intensive work. Human-intensive work is characterized by a high degree of unpredictability resulting from human factors, complexity, size, distribution, changing requirements, and the environment itself. Metrics therefore play a critical role in the success of such projects. At the same time, the implementation of metrics creates unique challenges such as the flexibility to adapt what is measured as situations change, and to configure how the metric is measured in different contexts of process execution.

In conventional business management systems the path from defining what metrics need to be collected in a given process to their collection is complicated and time consuming. For example, in most conventional business process management systems changing what gets collected can be very difficult. Also, there can be inconsistencies from project to project of what gets collected, how it gets collected, and when. Moreover, inconsistency can even occur in a given metric when measured across two executions of the same process because individuals differ in how and when they collect.

### BRIEF SUMMARY

In one embodiment, a method for managing metrics in a business process management environment is disclosed. The method comprises determining that a business process has been instantiated for execution. The business process is defined by a process definition. A set of process elements associated with the business process is identified based on the process definition. Each of the set of process elements is associated with a process element type. A set of metric configurations defines the overall set of metrics that should be collected by the process. Each individual configuration element associates at least one metric with at least one process element type in which it should be collected. Different configurations may associate the same metric to be collected by different element types. The business process is automatically configured to collect all the desired metrics whereby each process element corresponding to a process type that appears in the set of metric configurations is configured to collect one or more metrics that are specified by one or more of the configurations that specify that process element type.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention;

FIG. 2 illustrates one example the components for a metric framework according to one embodiment of the present invention;

FIG. 3 shows one example of a measurement lifecycle according to one embodiment of the present invention;

FIG. 4 shows one example of a metric template according to one embodiment of the present invention;

FIG. 5 shows one example of process definitions according to one embodiment of the present invention;

FIG. 6 shows one example of a metric configuration according to one embodiment of the present invention;

FIG. 7 shows one example of processes configured with metrics according to one embodiment of the present invention;

FIG. 8 is an operational flow diagram illustrating one example of managing metrics in a business process management environment according to one embodiment of the present invention; and

FIG. 9 is a block diagram illustrating one example of an information processing system according to one embodiment of the present invention.

### DETAILED DESCRIPTION

Processes, methods, and best practices define how an organization manages its work and are considered a critical factor for a business to reach its goals effectively. Examples of types of work that are described by processes include Custom Application Development, Service Oriented Architecture (SOA), and packaged application development, such as SAP ABAP implementation. Processes can be large and complex with many levels of tasks and detail.

In one embodiment, a process or business process is a structured flow of interrelated activities involving people, information, and/or technology intended to accomplish some goal. Different activities can be organized via different relationships, such as sequence or parallel, and these relationships may form a structure comprising of different process elements. Processes used by organizations to manage how people do work, such as Custom Application Development are sometimes referred to as Methods. Their hierarchical organization is often described by elements such as project, that comprises phases, that include activities, and that have tasks. When a process is executed by machines, such as getting weather information in a certain location, resources are in the form of data and activities are carried out by algorithms. Many processes include a combination of people and machine activities, such as requesting a loan from a bank. Information about the requestor and his financial history would be gathered automatically by machines and made available to the right human to decide if the loan should be approved.

In globally distributed environments (and other environments as well) accurately measuring the ongoing work is critical for both tactical and strategic purposes. From a tactical and more near-term perspective, measurements provide a mechanism for determining operational efficiency, risk, and detecting trouble. This facilitates the effective response to unexpected events and conditions that arise during service delivery. Metrics also provide a means to track progress, which is essential in supporting the coordination and planning of work (e.g. from a project management perspective). On a more strategic level, measurements provide a way to learn and gain insight from outcomes in order to better optimize future performance. Measurements can identify areas of focus for improvement in process, organization, governance, or tooling and may lead to better planning. As work is increasingly spread across different localities and organizations, the need to measure becomes even more important even as the challenges of providing support for measurement capabilities grow.

Processes can be defined by a designer using a specialized tool. Such tools typically define a hierarchy of process element types, such as task, activity, phase, and project. For each process element the process designer specifies specific attributes of a process such as inputs; outputs; the roles of people that are required to do the work; and the metrics that should be collected. When the process is enacted the process definition may be an input to a project management tool. In such cases the process definition becomes a work-breakdown structure (WBS). In situations where the process can be fully automated the process can be translated into a Business Process Execution Language (BPEL) that can be enacted on a given platform.

The process elements along with the metrics and key performance indicators (KPIs) that are to be collected and tracked for any given process element can all be specified within a process definition. This typically involves two types of subject matter experts (SMEs): process SMEs and metric SMEs. A process SME is concerned with the most efficient set of steps to accomplish a task. A metric SME is concerned with a broad set of concerns related to measurement of the process. These can include monitoring and validating the efficiency of a given process enactment; predictors and indicators of risk or trouble; metrics that can help improve the efficiency of the process itself; creation of baselines for estimation; tracking of financials; measuring the outcomes of predefined business goals, such as quality, schedule, or work allocation; etc.

Accordingly, the metric SME needs to first decide what metrics should be collected and then, for each metric, determine where in the process they should get collected. The latter is referred to as the configuration of metrics to a process. Different metrics get configured differently, as they may need to be collected for different process element types. For example, a metric such as “hours of work” may be associated with every task while a metric such as “hours to rework” needs to be collected only on tasks that involve “rework”. On the other hand, a metric such as “average effort variation” needs to be collected on a higher level element, such as a phase or even a project, since variation among different individual tasks is not informative.

The above method for creating a process definition has various disadvantages. For example, creating or modifying a process definition requires the expertise of both a process and metric SME. Thus, even adding or removing a few simple steps from a process definition requires involvement of a metric SME to carefully specify the necessary corresponding changes in metrics. Also, adding or removing a metric from a process can also be complicated. The process definition needs to be reviewed by both process and metric SMEs to ensure that new metrics will be collected correctly and that the removal of an existing metric will not impact other metrics that may require this metric as part of their calculations. Different process enactment contexts, such as work done in a different geography or for a different customer, may necessitate a different approach to the collection of metrics, or require that metrics that were defined to be collected in one WBS element be collected in another. This can be handled on a case-by-case basis in what is referred to as a Method Adoption Workshop (MAW). This is both time consuming and error prone. Similarly, additional metrics may be required because a specific customer demands them, or because of some government regulation in the locality of its execution. Modifying a process and its metrics on a case by case basis can be complicated. Furthermore, unexpected events may require changing the metrics during the life time of a process execution. For example, consider a project is experiencing a problem and is not executing as expected. In such a case one may want to add additional metrics or modify existing metrics to more closely scrutinize execution or help bring the project back into health.

Various embodiments of the present invention overcome the above problems by decoupling the definitions of a process from the metrics that need to be collected for the process. Thus, changes in one can be made independently of the other. Metrics are defined in a generic fashion and these metric definitions are correctly bound to a given process definition by metric configurations. If a customer requires additional metrics in a specific enactment one or more embodiments automatically and correctly configures the additional metrics within a WBS structure created from the process definition. This flexibility saves considerable time and greatly reduces the risk of errors. The decoupling also provides a separation of concerns which allows process and metric SMEs to focus on their individual tasks.

Operating Environment

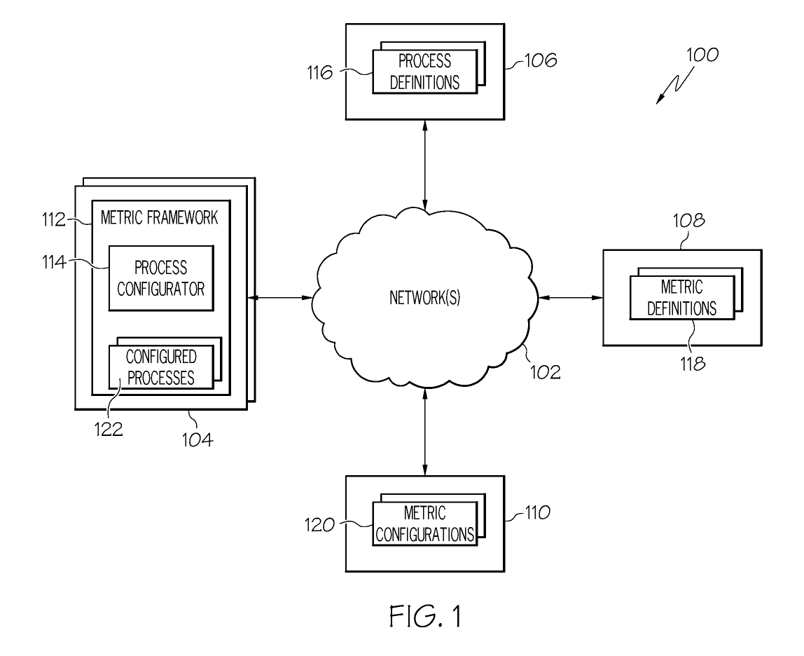

FIG. 1 shows one example of an operating environment 100 according to one embodiment of the present invention. The operating environment 100 of FIG. 1 can be a cloud computing environment or a non-cloud computing environment. The operating environment 100 includes one or more networks 102 that, in one embodiment, can include wide area networks, local area networks, wireless networks, and/or the like. The operating environment 100 also comprises one or more information processing systems 104 and one or more repositories 106, 108, 110 that are communicatively coupled to the network(s) 102.

The information processing system 104 comprises a metric framework 112 (also referred to herein as a (“metric management environment”) that automates the path from definition to collection. The metric framework 112 supports the loose coupling of metric definitions to abstract process elements referred to as “measurables”, which are units of measurements. The metric framework 112 also allows for both metrics and processes to vary independently of one another. In one non-limiting example, the metric framework 112 is based on an abstract model of service delivery as a decomposition according to a protocol referred to as Work-as-a-Service (WaaS). A more detailed discussion of WaaS is given in D. V. Oppenheim, L. R. Varshney, and Y.-M. Chee, “Work as a service,” in Service-Oriented Computing, ser. Lecture Notes in Computer Science, G. Kappel, Z. Maamar, and H. R. Motahari-Nezhad, Eds. Berlin: Springer, 2011, vol. 7084, pp. 669-678, which is hereby incorporated by reference in its entirety.

The metric framework 112 includes a process configurator 114 that takes as input at least one process definition 116, a set of metric definitions 118, and a set of metric configurations 120 and outputs an automatically configured process 122 based thereon. This process 122 is automatically configured to collect the proper metrics for the process based on a given process definition and metric configuration information. Each of the process definitions 116, the set of desired metrics 118, and the set of metric configurations 120 are separate and distinct from each other and reside in one of the repositories 106, 108, 110. However, it should be noted that two or more of these components can reside within the same repository as well. Each of the components shown in FIG. 1 is discussed in greater detail below.

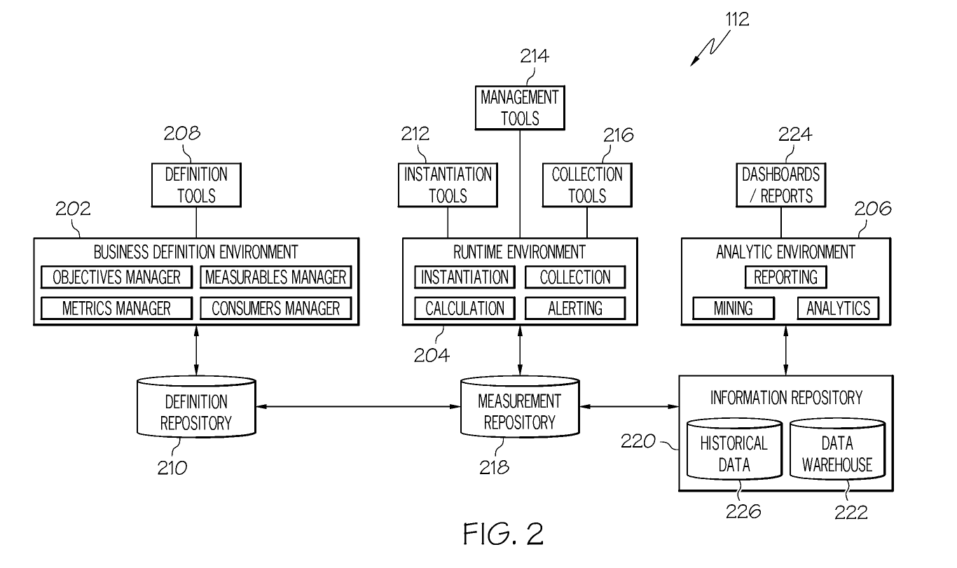

FIG. 2 shows a more detailed example of the metric framework 112 of FIG. 1. In the example shown in FIG. 2, the metric framework 112 comprises a business definition environment 202, a runtime environment 204, and an analytics environment 206, which correspond to various phases of a measurement lifecycle, e.g., define, use, and improve. It should be noted that each of these environments can reside in a single information processing system or on different information processing systems. In another embodiment, one or more of these environments can be distributed across multiple information processing systems.

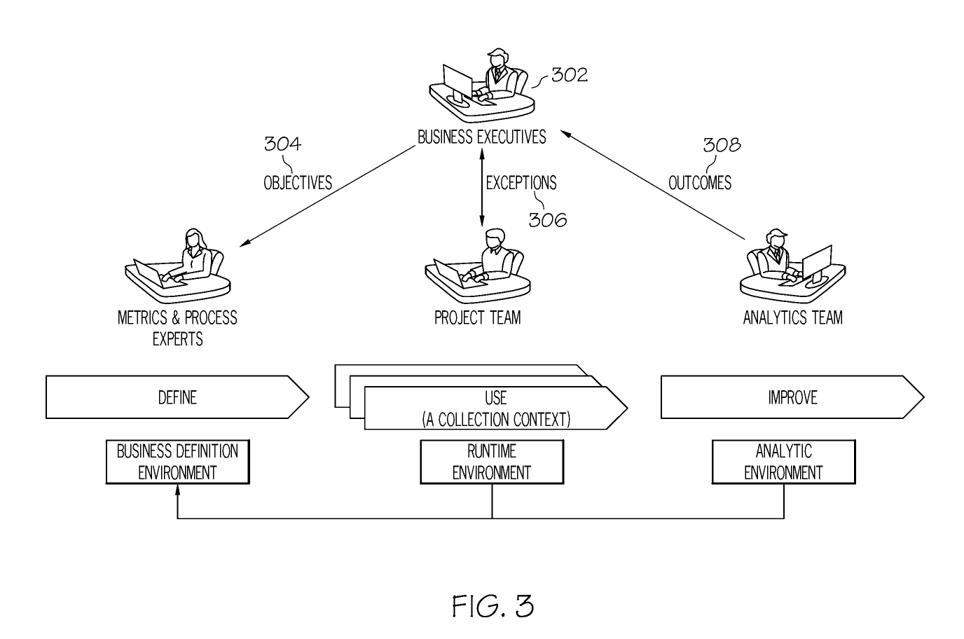

FIG. 3 shows one example of a measurement lifecycle supported by the metric framework 112 alongside key stakeholders and actors. In this embodiment, the metric framework 112 can be configured (but is not limited to) to support a large service provider organization with globally distributed delivery teams that specialize in different industries and competencies. Business executives 302, using the business definition environment 202, determine business objectives 304, such as KPIs for productivity, quality, or throughput. Metric and process subject matter experts (SMEs) break down the high level business objectives and define what metrics should get collected by different processes, where in each process they apply, and when they should get collected. As delivery projects are enacted, the appropriate metric definitions get instantiated into the runtime environment 204 that supports metrics collection. Runtime exceptions 306 trigger a resolution activity that may initiate executive decision making if severe. This may result in changing one or more metrics or adding additional metrics to be collected. The collected metrics are then passed into the analytic environment 206 that generates reports and dashboards (outcomes 308) and facilitates historical analysis for ongoing improvements. The outcomes for each business objective are then communicated back to the business executives.

Referring back to FIG. 2, the business definition environment 202 is used by metric and process SMEs to define business objectives, metric templates, measurables, and consumers. Objectives represent various executive and stakeholder concerns, such as quality, productivity, health, or utilization. These objectives determine what metrics are to be collected. Every measurement contributes to quantify the outcome of any business objectives it relates to.

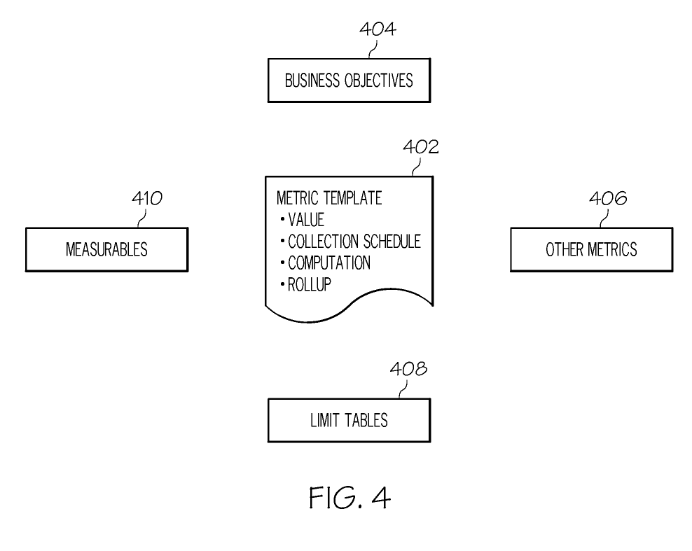

Metric templates are included within measurements, which can be primitives or calculations such as formulas or analytics. Various attributes of a metric template 402 and its relationship to other objects 404, 406, 408, 410 are illustrated in FIG. 4. Attributes specify the value type and range that are to be collected and a collection schedule or frequency. If the metric is a computational metric then the metric specifies the computational formula in a declarative fashion. If a metric's value is to be rolled up across different levels of a WBS, for example collected on a task and rolled up all the way to a phase, then the rollup formula is also specified. A metric template relates to several other objects: all the business objectives it contributes to, other metrics it may require for computation, the tables that specify acceptable and unacceptable ranges of values for the metric, and the measurable(s) that require it be collected.

Measurables represent the items of interest and that are to be measured. A measurable may correspond to varying levels of granularity within a WBS, such as task, activity, phase, or project. As work becomes more componentized and teams become highly differentiated by skill, both the planning and estimation of delivery projects tends to be done through the specification of work components. Collecting metrics on a project or phase level does not provide sufficient insight into the finer grain components of work. By utilizing measurables, any level of granularity of work can be defined and measured.

Measurables also address a much deeper issue. Different types of specialized work may require different or additional metrics. Consider, for example, a work component for creating an ETL (Extract, Transform, Load) from a set of data sources to a data warehouse. An estimate of the required effort for the work may be based on various assumptions, such as the number of data sources or the size or complexity of the schema. In order to both validate the estimate and calibrate it to improve future accuracy, actual data relating to these assumptions need to be collected. A measurable, therefore, is a conceptual entity that can represent many different types of work in a way that makes it simple for a metrics SME to define any additional metrics that are specific to it. Note that measurable may be also be used for non-work-related entities, such as work-products, resources, or organizations.

On a more fundamental level, a measurable represents a component of work. An emerging paradigm called Work-as-a-Service (WaaS) models distributed work that is carried out in service delivery utilizing service oriented principles. The foundational idea behind WaaS is to separate between the concerns of doing and coordinating work. The doing of work is encapsulated as a service request between a requestor and a provider. The basic construct in the WaaS framework is an encapsulated service request that isolates each service provider and facilitates the modular organization of work. In this view projects are assembled as compositions of interconnected service requests. The coordination of work involves routing each service request to the optimal service provider. WaaS is based on an information flow model that distinguishes between two types of information: payload and coordination. Payload information conveys to the provider all the information that is needed to execute the work. Coordination information can be seen as sensors that are injected by the requestor to provide it with the desired level of visibility. From a pragmatic viewpoint, coordination information can be thought of as metrics and is supported by one or more embodiments of the present invention.

In an execution environment that is supported by WaaS components, a measurable maps directly to a WaaS component. The metric framework 112 can then be utilized to specify the coordination information. In a more standard project environment that is managed through a project tool the project manager needs to map sub-trees of his project plan (WBS) to measurable definitions in the framework 112. Once this mapping is in place, the required metrics are automatically instantiated for collection in framework's runtime environment 202.

Consumers represent entities such as reports, dashboards, alerts, or analytics. To understand consumer consider a report or project quality in terms of defect density that can be divided by service line, development tool, and geography. In this example all projects collect defect density measurements and enter this into a centralized data warehouse. This data warehouse has schemas for both facts and dimensions. The fact table includes the defect density data. Dimension tables specify service lines, development tools, and geographies. However, there is now a problem of mapping the facts from each project to the required dimensions; such problems often lead to significant inconsistencies and delays. By associating a consumer with a desired report, a metrics SME can specify both the required measurements (defect density) as well as the dimensions (service line, development tool, geography).

If a collection context specifies a consumer, then both the metrics and the dimensions are automatically specified for collection, ensuring consistency across projects and greatly simplifying the creation of the report. In one example, a collection context represents different work execution environments, such as projects. Collection contexts can specify the utilization of different tools or methods, different customer environments, different geographies, or the need to comply with different regulations. Accordingly, each collection context may require a unique set of metrics. When a project gets enacted, its collection context is also specified, bringing in any additional metrics that may be required.

The definition of business objectives, metric templates, measurables, and consumers is aided by definition tools 208, and the output of the defining operations is stored in a definition repository 210. In one embodiment, this repository comprises the process definitions 116, the metric definitions 118, and the metric configurations 120. However, as discussed above, each of these components can be stored in separate repositories.

When a new project is enacted, an execution context is created for it in the runtime environment 204. First, the right metrics are instantiated from the definition environment 202 via instantiation tools 212. Then the runtime manages the collection and monitoring of metrics, via management and collection tools 214, 216, and supports automation, consistency, and flexibility. The collected metrics are stored within a measurement repository 218 as measurements. Instantiation provides the runtime environment 204 with everything it needs to support a project. This includes all the metrics that are defined by the service organization, the measurables that are defined for this context with any additional metrics they bring in, and all specified consumers with their additional metrics and dimensions. Instantiation can be highly complex and is therefore fully automated. Following instantiation the runtime environment 204 knows what measurements need to be collected and when. As metrics are collected their values are compared against baseline values, and if they fall out of a predetermined range, exceptions are raised. As primitive values are collected, the value of computed metrics, such as formulas or analytics, is updated.

At regular intervals metrics are exported to the analytic environment 206. This environment comprises an information repository 220. The information repository 220 includes a standard business intelligence data warehouse 222 for generating reports and dashboards 224. The information repository 220 also includes a historical database 226 that is used for analytics and ongoing improvements.

Automatic Configuration Of Process Definition Metrics

As discussed above, the metrics framework 112 automates the path from definition to collection and supports the loose coupling of metric definitions to abstract process elements, i.e., measurables. The metrics framework 112 automates the definition-collection path by allowing measurements to vary dynamically by context. This becomes especially important when it is desirable to optimally route work in a work-as-a-service fashion based on changing context. The automation provided by the metrics framework 112 removes the possibility of error in translating metrics requirements to design and implementation that occurs when developers must be involved in order to operationalize metrics. This is especially true if work crosses many system boundaries and the collection process is spread across those systems. Another disconnect arises when the data must be utilized for reporting and analysis. Once again, the report author needs to interpret the metric specifications in document form, relate them manually to the data collected in the spreadsheet, database, or data warehouse, and code the reports and analytics which use the metric data as inputs.

In one embodiment, a metrics subject matter expert or stakeholder directly authors the definitions of measurements using a metrics definition interface to the metric definition repository 108. The metrics definition interface is provided by the metrics framework 112. This interface allows for the creation of measurements of many different types, ranging from primitive metrics such as numeric data, dates and times, enumerations, to formulas. Formula metrics incorporate the definition of the formula computation, so that the definition itself is used directly to compute the resulting metric. This ensures that the metric definition is implemented faithfully and accurately. Once authored, metric definitions 118 can be immediately incorporated into the collection process, thus shortening the time from definition to deployment. This enables the metrics framework 112 to support dynamically adjusting metrics based on (potentially rapidly changing) context.

The metrics framework 112 provides a loose coupling between the definition of metrics and a process as follows. In one embodiment, processes are defined in terms of process elements, where each process element p is of a process element type t. Examples of a process element type are tasks, activities, phases, projects, etc. A process element type, in one embodiment, specifies the inputs, outputs, and roles associated with it. Within a process, process elements are put together using relationships, such as parent-child, sequence or parallel; where each relationship 1 is a triple which includes the relationship type r, and the two related process elements p1 and p2. The process element types are arranged in a hierarchy that determines which types can appear as the parent or child of another process element type. Therefore, a specific process P can be defined as the set of process elements p(t) that comprise it, along with the set of relationships l(r, p1, p2). The process definitions 116 are stored in the process definition repository 106.

A Metric m is stored as a separate definition 118 from the process definition 116 in the metric definition repository 108. Metric definitions, in one embodiment, specify the name of the metrics, the type of value to be collected, and other attributes. Metrics can be grouped together in a Process Metric Bundle B={m₁, m₂ . . . mₙ}. This defines the set of all the metrics that can be collected during an enactment of processes. Metric definitions 118 are stored within the metric definition repository 108. This repository 108 can be separate from or combined with the process definition repository 106.

Metrics can be defined for collection by specifically associating the desired metrics with the appropriate process elements. However, this means that whenever the process is modified, the metrics SME needs to examine the process changes and manually adjust the metrics on each modified or newly introduced Process Element. Therefore, the metrics framework 112 utilizes Metric Configurations, which represent the configuration of a given metric m in a process-independent manner. In one embodiment, a metric configuration c is a tuple (m, t) comprising a metric m, and the process element type t for which the metric is to be collected. Note that the process element types are common to all processes, making the configuration process independent. Metric configurations 120 are stored in the metric configuration repository 110. In one embodiment, the metric configuration repository can be combined with the metric definition repository 118. It should be noted that since the metric configurations 120 identify a given metric to be collected for a given process element type, metric definitions 118 are not required. In another embodiment, the metric definitions 118 are used by users to identify the types of metrics available for collection when generating a metric configuration 120.

The process configurator 114 automatically configures an input process P from the process definition repository 116 for collection of a set of metrics (defined in the metric definition repository 118), according to the metric configurations 120 stored in the metric configuration repository 120. The output of the process configurator 114 is a configured process 122, which can then be enacted using a runtime platform 204 that provides support for process execution and metrics collection.

For example, given:
a process definition P that comprises a set of elements {p₁, p₂, . . . , pₙ},
an optional process metric bundle B={m₁, m₂, . . . , mₘ}, that defines the set of metrics that are available for collection by a process P, and
a set of metric configurations C={c₁, c₂, . . . , cₙ}, where there is one configuration cᵢ for each metric mᵢ
   The process configurator 114 determines the metrics to be collected in the following way:

1.) For each process element p with process element type t,

2.) For each configuration element cⱼ in C,

3.) IF the metric configuration cⱼ specifies that metric mⱼ is to be collected on process element type t,

4.) THEN add metric mⱼ to be collected during the lifecycle of element pᵢ.

It is often desirable to limit collection of a metric to only some instances of a given process element type. For example, a metric such as “Time to fix Bug” should only be attached to activities that relate to fixing a bug. Therefore, the metric framework 112 provides a new element called a Tag, which is a unique text field that describes some semantic aspect of the process element. In this embodiment, the process element definition p is extended to include the set of tags Tₚ={t₁, t₂, . . . , tₙ}, which are associated with it (where the set of tags could be the empty set { }). The structure of the metric configuration c is extended to include a set of tags as well, such that c=(m, t, T_{c}), where m is the metric to be collected, t is the process element type for which m is to be collected, and if the set of tags T_{c} is not the empty set, then metric m is only to be collected on process elements of type t for which the set of tags associated with the process element (Tₚ) includes at least one of the tags in T_{c} (i.e. Tₚ∩T_{c}≠{ }).

In this embodiment, the metric framework 112 configures the metrics as follows:

1.) For each process element pᵢ with process element type t and tags Tₚ_{ᵢ},

2.) For each configuration element cⱼ in C,

3.) IF the metric configuration cⱼ specifies that metric mⱼ is to be collected on process element type t AND the set of tags T_{c}_{ⱼ} for cⱼ is the empty set { }OR Tₚ_{ᵢ}∩T_{c}_{ⱼ}≠{ }.

4.) THEN add metric mⱼ to be collected during the lifecycle of element pᵢ.

The loose coupling described above allows the tasks of metric definition/configuration and process definition/management to take place separately without requiring tight interaction for changes on either side. This enables metrics to be modified rapidly to address changing context, while also allowing processes to evolve as needed. In particular, the process of metric definition/configuration can be performed once and shared across many different processes. At the same time, the metric framework 112 supports configuration contexts, which can for example be used to define configurations for different organizations. For example, it may be desirable sometimes to have configurations that are context specific such as collecting the metric “average effort variation” on the Phase Process Element Type, whereas in another context it may be desirable to collect this metric on the Process element Type. Therefore, the metric framework 112 provides configuration contexts to which metric configurations can be associated. When a process is enacted in a given context, the configurations that are selected as input to the process configurator 114 come from the appropriate context. Configuration contexts can be arranged in a hierarchy, such that child context inherit definitions and configurations from their parent context. In this way, standard metrics can be defined at a global level, with additional metrics to address more specific concerns defined at lower levels of an organizational structure. In another embodiment, additional metrics can be easily added to an already configured process 122. For example, the metric SME need only define a configuration for each new metric, and possibly its context, and the process configurator 114 configures the process 122 with the new metric (or metrics) and its/their configuration (or configurations). Similarly, one or more metrics can be removed from an already configured process 122.

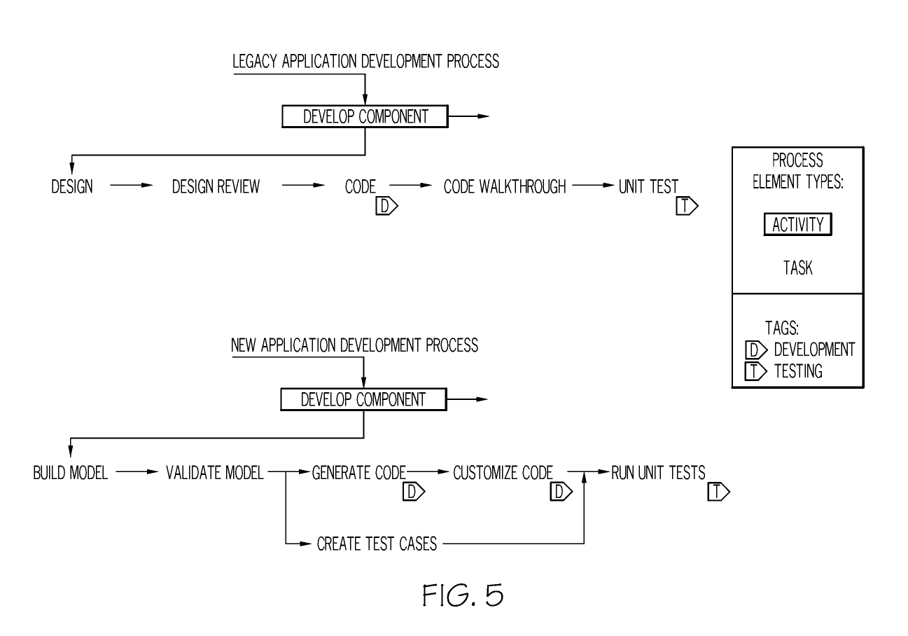

As an example of the metric framework's loose coupling of metrics and process, consider a Defect Injection Rate metric that measures the rate at which defects are generated during a software development process by dividing the count of known defects by the hours of development effort. Within an organization, further suppose that there are several different software development processes that are utilized by different lines of business in the organization, but all are required to measure Defect Injection Rate. Within the legacy application development organization, the process for development includes activities comprised of the following tasks: Design, Design Review, Code, Code Walkthrough, and Unit Test. Meanwhile, the new application development organization employs a process with activities containing the steps: Build Model, Validate Model, Create Test Cases, Generate Code, Customize Code, and Run Unit Tests. A partial process definition for both the legacy application and new application development processes is shown in FIG. 5.

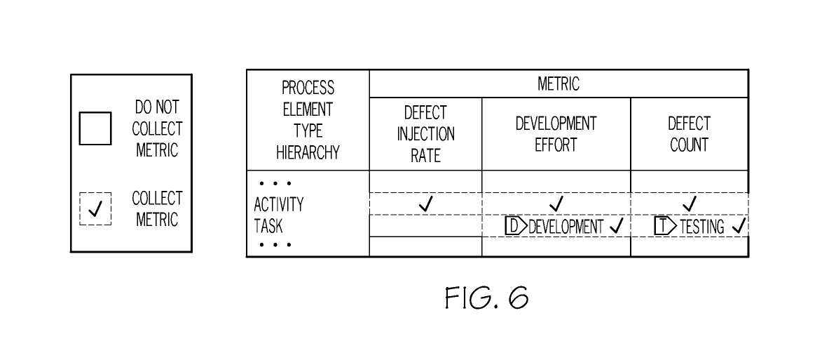

In a typical workflow-based measurement system, the measurement subject matter expert would be required to examine each task in the two processes and explicitly associate the metrics that are to be collected with the specific tasks. Changes to process would require this examination to be redone. However, with the metric framework 115 instead of manually inserting the required metrics, the metrics SME simply authors a single set of metric configurations for the Defect Injection Rate formula metric and the two primitive metrics upon which it depends. The configuration for Defect Injection Rate states that it is to be collected at the Activity level, while the Defect Count and Development Effort metrics are to be captured at the Task level and rolled up to the Activity Level, where they are then used to calculate the Defect Injection Rate. Furthermore, the Defect Count is associated with a “Testing” tag, while the Development Effort metric is associated with a “Development” tag. These configurations are illustrated in FIG. 6, where the dashed boxes indicate that the metric (column) is to be collected for the specified process element type (row). When collection is restricted to a subset of the process elements of a particular type, the tag(s) that denote the subset are listed in the cell.

The process SME is able apply the appropriate tags to each task in the process to ensure proper collection. In the case of the legacy application process, the Design and Code tasks are marked as “Development”, while the Unit Test task is given the “Testing” tag. Meanwhile, the process SME for the new application process tags the Generate Code and Customize Code tasks as “Development” and the Run Unit Tests task as “Testing”. These tags are indicated by the tag-shaped symbols in FIG. 5.

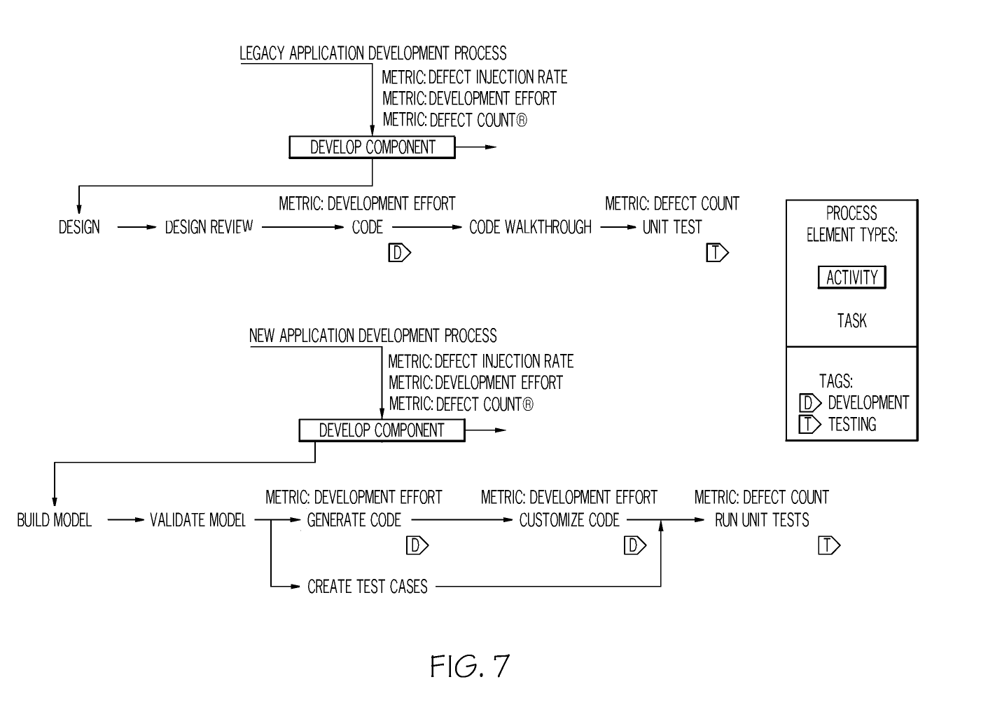

The tagged process is then fed into the configurator 114 along with the metric configurations 118 described above. The resulting configured process executes in a workflow engine which presents an interface for collecting metrics according to the associations shown in FIG. 7. In other words, for both processes, the Defect Injection Rate, Development Effort, and Defect Count metrics are collected for each Develop Component activity (the ® symbol indicates that the value of Development Effort and Defect Count is automatically rolled up from child tasks). However, for legacy application development, Development Effort is collected on the Code task, whereas for new application development, it is collected on both Generate Code and Customize Code tasks. Likewise, the Defect Count metric is collected on the Unit Test task of legacy development process instances, while it is collected on the Run Unit Tests task of new development instances.

In addition to the above, the metric framework 112 also addresses other crucial concerns for a metrics framework. Since measurements are only as useful as the quality of the data, the framework provides data connectors which allow metric values to be populated automatically from different sources of information, avoiding the need for manual data entry wherever possible.

With respect to the use of measurements, the metric framework 112 provides mechanisms for defining control limits on metrics that enable the triggering of alerts when metric values exceed control limits. This provides immediate visibility to problems that occur during process execution. Also, the metric framework 112 supports the definition of dashboards and reports which provide addition insight on the status of ongoing work, along with the ability to export metric information to data warehouses or other analytic engines.

Operational Flow Diagrams

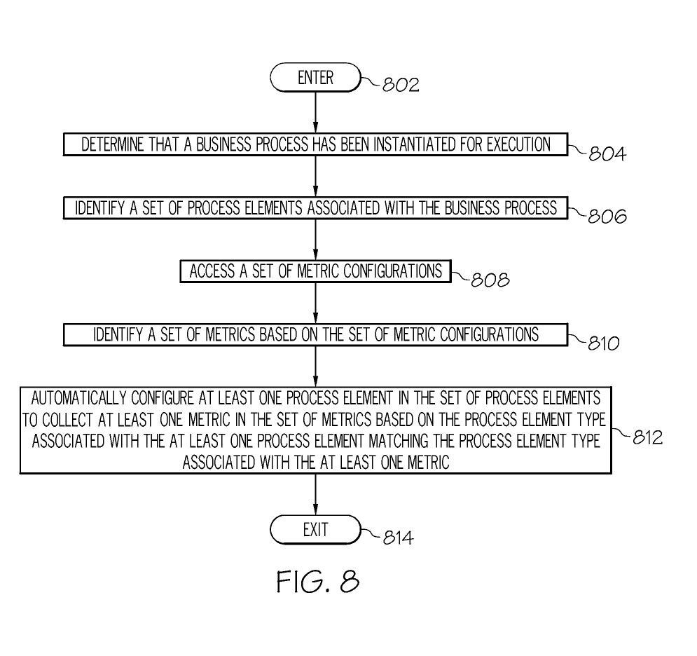

FIG. 8 is an operational flow diagram illustrating one example of managing metrics in a business process management environment. The operational flow diagram of FIG. 8 begins at step 802 and flows directly to step 804. The process configurator 114, at step 804, determines that a business process has been instantiated for execution. The business process is defined by a process definition 116. The process configurator 114, at step 806, identifies, based on the process definition 114, a set of process elements associated with the business process. Each of the set of process elements is associated with a process element type. The process configurator 114, at step 808, accesses a set of metric configurations 120 based on the business process having been instantiated for execution. The process configurator 114, at step 810, identifies, based on the set of metric configurations 120, a set of metrics for at least one of the process element types. The process configurator 114, at step 812, automatically configures at least one process element in the set of process elements to collect at least metric in the set of metrics based on the process element type associated with the at least one process element matching the process element type associated with the at least one metric.

Information Processing System

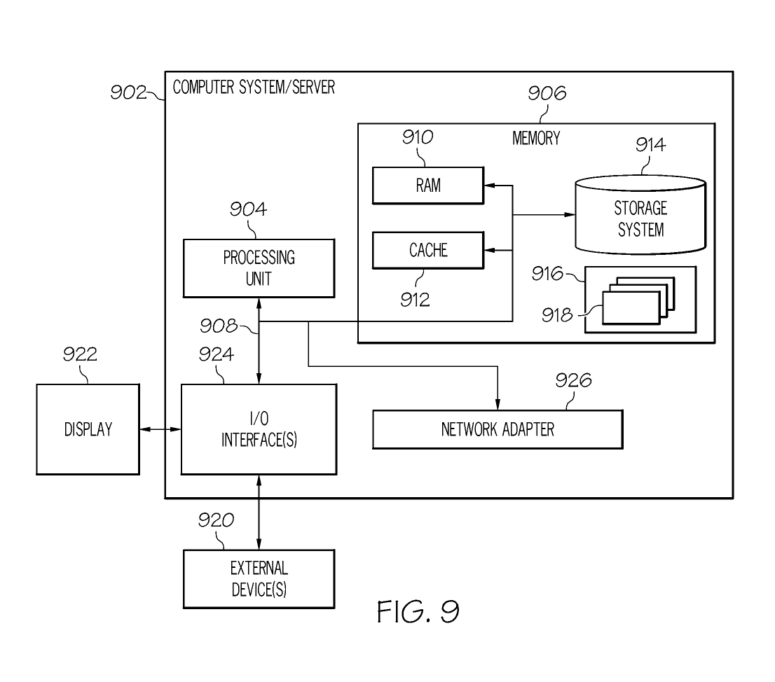

Referring now to FIG. 9, this figure is a block diagram illustrating an information processing system that can be utilized in embodiments of the present invention. The information processing system 902 is based upon a suitably configured processing system configured to implement one or more embodiments of the present invention (e.g., the system 104 of FIG. 1). Any suitably configured processing system can be used as the information processing system 902 in embodiments of the present invention. The components of the information processing system 902 can include, but are not limited to, one or more processors or processing units 904, a system memory 906, and a bus 908 that couples various system components including the system memory 906 to the processor 904.

The bus 908 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 9, the main memory 906 includes the metric framework 112 and the process configurator 114. In another embodiment, the metric framework 112 and/or the process configurator 114 can reside within the processor 904, or be a separate hardware component.

The system memory 906 can also include computer system readable media in the form of volatile memory, such as random access memory (RAM) 910 and/or cache memory 912. The information processing system 902 can further include other removable/non-removable, volatile/non-volatile computer system storage media. By way of example only, a storage system 914 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 908 by one or more data media interfaces. The memory 906 can include at least one program product having a set of program modules that are configured to carry out the functions of an embodiment of the present invention.

Program/utility 916, having a set of program modules 918, may be stored in memory 906 by way of example, and not limitation, as well as an operating system, one or more application programs, other program modules, and program data. Each of the operating system, one or more application programs, other program modules, and program data or some combination thereof, may include an implementation of a networking environment. Program modules 918 generally carry out the functions and/or methodologies of embodiments of the present invention.

The information processing system 902 can also communicate with one or more external devices 920 such as a keyboard, a pointing device, a display 922, etc.; one or more devices that enable a user to interact with the information processing system 902; and/or any devices (e.g., network card, modem, etc.) that enable computer system/server 902 to communicate with one or more other computing devices. Such communication can occur via I/O interfaces 924. Still yet, the information processing system 902 can communicate with one or more networks such as a local area network (LAN), a general wide area network (WAN), and/or a public network (e.g., the Internet) via network adapter 926. As depicted, the network adapter 926 communicates with the other components of information processing system 902 via the bus 908. Other hardware and/or software components can also be used in conjunction with the information processing system 902. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for managing metrics in a business process management environment, the method comprising:
determining that a business process P has been instantiated for execution, wherein a business process is a structured flow of interrelated activities intended to accomplish one or more goals;
identifying a set of process elements {p₁, . . . , pₙ} associated with the business process P, wherein each process element pᵢ of the set of process elements {p₁, . . . , pₙ} is associated with a process element type tₚ;
accessing, based on the determining, a set of metric configurations C where C={c₁, . . . , cₙ}, and wherein each configuration cᵢ in the set of metric configurations C identifies a metric mᵢ to be collected for a process element type tₘ, wherein the set of metric configurations C is configured to comprise at least a first metric configuration c₁ associated with a given process element type tₚ₁ and at least a second metric configuration c₂ associated with the given process element type tₚ₁, wherein the first metric configuration c₁ and the second metric configuration c₂ identify a first metric m₁ and a second metric m₂, respectively, that are to be collected for the given process element type tₚ₁ for different instantiations of the business process P, wherein the first metric m₁ and the second metric m₂ are different from each other;
identifying, based on the set of metric configurations C, a set of metrics {m₁, . . . , mₙ} to be collected for the process element type tₘ associated with each metric in the set of metrics {m₁, . . . , mₙ}; and
automatically configuring, with at least one processor, at least one process element pₙ in the set of process elements {p₁, . . . , pₙ} to collect at least one metric mₙ in the set of metrics {m₁, . . . , mₙ} based on a process element type tₚₙ of the at least one process element pₙ matching a process element type tₘₙ associated with the at least one metric mₙ.

2. The method of claim 1, wherein the business process is defined by a process definition, and wherein the set of process elements are identified based on the process definition.

3. The method of claim 2, wherein the process definition and set of metric configurations are created independent of each other.

4. The method of claim 1, wherein the process element types are organized in a hierarchy.

5. The method of claim 1, wherein each of the set of metric configurations comprises a tuple identifying the process element type and the metric to be collected for the process element type.

6. The method of claim 1, wherein each of the set of process elements specifies at least one of an input, an output, and a role associated with the process element type.

7. The method of claim 1, further comprising:
identifying, based on a process definition defining the business process, at least one tag associated with at least one process element in the set of process elements;
identifying, based on the set of metric configurations, a set of tags associated with a process element type, wherein each of the set of tags is associated with at least one metric in the set of metrics; and
determining the at least one tag associated with the at least one process element matches the tag in the set of metric configurations for the process element type associated with the at least one process element.

8. The method of claim 7, wherein the set of tags are included within at least one of the set of metric configurations.

9. The method of claim 7, wherein the automatically configuring comprises:
based on the at least one tag associated with the at least one process element matching a tag in the set of tags, automatically configuring the at least one process element to collect the metric associated with the tag in the set of tags.

10. The method of claim 1, further comprising:
determining a context in which the business process is to be executed, wherein the accessing comprises,
determining that the set of metric configurations are associated with the context; and
accessing the set of metric configurations based on determining that the set of metric configurations are associated with the context.

11. (canceled)

12. The method of claim 1, further comprising:
determining, after the business process has been automatically configured, that at least one process element of a given process element type is not collecting at least one metric in the set of metrics associated with the given process element type; and
automatically configuring, based on determining that at least one process element of a given process element type is not collecting at least one metric, the business process to collect the at least one metric in the set of metrics associated with the given process element type.

13. The method of claim 1, wherein the automatically configuring further comprises:
determining one of
the at least one metric is collectable; and
the at least one metric is automatically derivable from values of other metrics.

14. The method of claim 1, wherein at least one of the set of metric configurations is dynamically updatable.

15. The method of claim 7, wherein the at least one tag is a unique text field that describes at least one semantic aspect of the at least one process element.

16. The method of claim 1, wherein the at least one process element pₙ in the set of process elements {p₁, . . . , pₙ} is associated with a set of tags G_{b}, and wherein at least one metric configuration cₙ in the set of metric configurations C comprises a set of tags G_{c}, the at least one metric configuration cₙ identifying the metric mₙ in the set of metrics {m₁, . . . , mₙ} and the process element type tₘₙ for which the metric mₙ is to be collected.

17. The method of claim 16, further comprising:
based on the process element type tₘₙ associated with the at least one metric configuration cₙ matching the process element type tₚₙ of the process element pₙ, determining that the set of tags G_{b} associated with the at least one process element pᵢ comprises at least one tag in the set of tags G_{c} associated with the at least one metric configuration cₙ.

18. The method of claim 17, wherein the automatically configuring comprises:
based on determining that the set of tags G_{b} associated with the at least one process element pₙ comprises at least one tag in the set of tags G_{c} associated with the at least one metric configuration cₙ, automatically configuring the at least one process element pₙ to collect the at least one metric mₙ identified by the at least one metric configuration cₙ.
